(19) United States
(12) Patent Application Publication
(10) Pub. No.: US 2004/0151874 A1
(43) Pub. Date: Aug. 5, 2004

(54) Collapsible photograph supporting device

(76) Inventor: Derek Cowie, London (GB)

Correspondence Address: LINGBECK PATENT LAW OFFICE, P.O. BOX 500, ST. MICHAEL, MN, 55376, US

(21) Appl. No.: 10/353,875

(22) Filed: Jan. 30, 2003

(51) Int. Cl. B32B 3/04

(52) U.S. Cl. 428/121; 428/136

(57) ABSTRACT

A collapsible photograph supporting device for displaying photographs upon generally flat surfaces. The collapsible photograph supporting device includes a sheet of rigid material having top and bottom edges and also having one or more main folds extending from said bottom edge to the top edge and dividing the sheet of rigid material into sections and also forming one or more corners upon which one or more photographs is mounted for display with the sheet of rigid material being adapted to rest upon a surface.

### BACKGROUND OF THE INVENTION

1. Field of the Invention

The present invention relates to standing photograph holders and more particularly pertains to a new collapsible photograph supporting device for displaying photographs upon generally flat surfaces.

2. Description of the Prior Art

The use of standing photograph holders is known in the prior art. More specifically, standing photograph holders heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. No. 3,050,887; U.S. Pat. No. 2,600,429; U.S. Pat. No. 4,965,946; U.S. Pat. No. 5,080,316; U.S. Pat. No. 5,458,242; U.S. Pat. No. 5,784,816; and U.S. Pat. No. Des. 354,621.

While these devices fulfill their respective, particular objectives and requirements, the aforementioned patents do not disclose a new collapsible photograph supporting device. The prior art describes inventions having frames and stands upon which photographs are supported and displayed.

### SUMMARY OF THE INVENTION

The general purpose of the present invention, which will be described subsequently in greater detail, is to provide a new collapsible photograph supporting device which has many of the advantages of the standing photograph holders mentioned heretofore and many novel features that result in a new collapsible photograph supporting device which is not anticipated, rendered obvious, suggested, or even implied by any of the prior art standing photograph holders, either alone or in any combination thereof. The present invention includes a sheet of rigid material having top and bottom edges and also having one or more main folds extending from said bottom edge to the top edge and dividing the sheet of rigid material into two sections and also forming one or more corners upon which one or more photographs is mounted for display with the sheet of rigid material being adapted to rest upon a surface. None of the prior art includes the combination of elements of the present invention which allows for photographs to be easily and conveniently displayed.

There has thus been outlined, rather broadly, the more important features of the collapsible photograph supporting device in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

It is an object of the present invention to provide a new collapsible photograph supporting device which has many of the advantages of the standing photograph holders mentioned heretofore and many novel features that result in a new collapsible photograph supporting device which is not anticipated, rendered obvious, suggested, or even implied by any of the prior art standing photograph holders, either alone or in any combination thereof.

Still another object of the present invention is to provide a new collapsible photograph supporting device for displaying photographs upon generally flat surfaces.

Still yet another object of the present invention is to provide a new collapsible photograph supporting device that is easy and convenient to set up and use.

Even still another object of the present invention is to provide a new collapsible photograph supporting device that can be placed anywhere and can take on many fanciful designs.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a new collapsible photograph supporting device according to the present invention.

FIG. 2 is a cross-sectional view of the present invention.

FIG. 3 is another cross-sectional view of the present invention.

FIG. 4 is a perspective view of the present invention.

FIG. 5 are perspective views of various embodiments of the present invention.

### DESCRIPTION OF THE PREFERRED EMBODIMENT

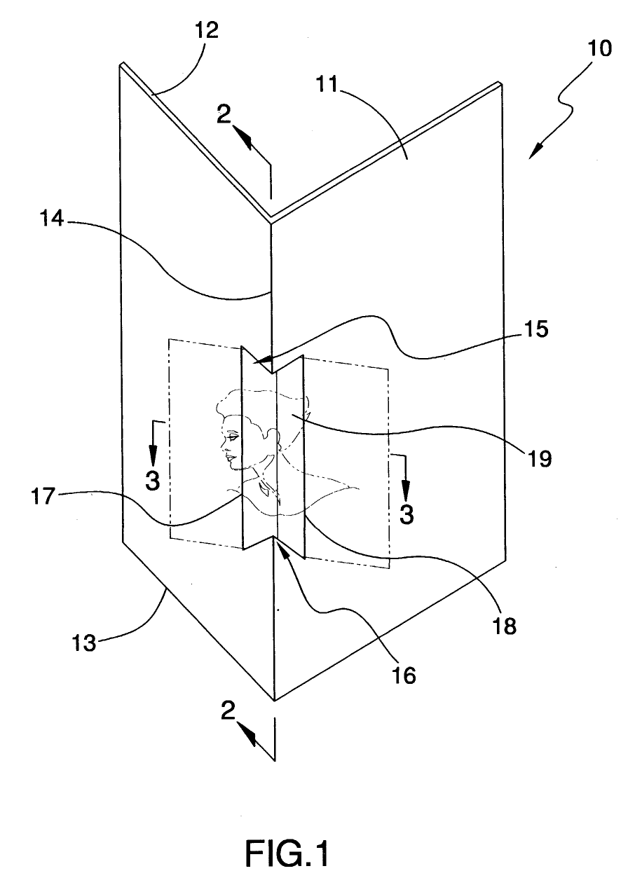

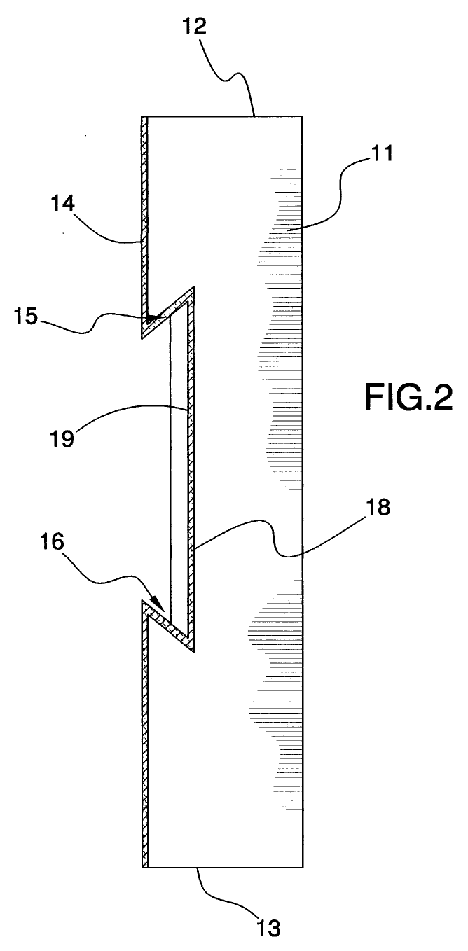

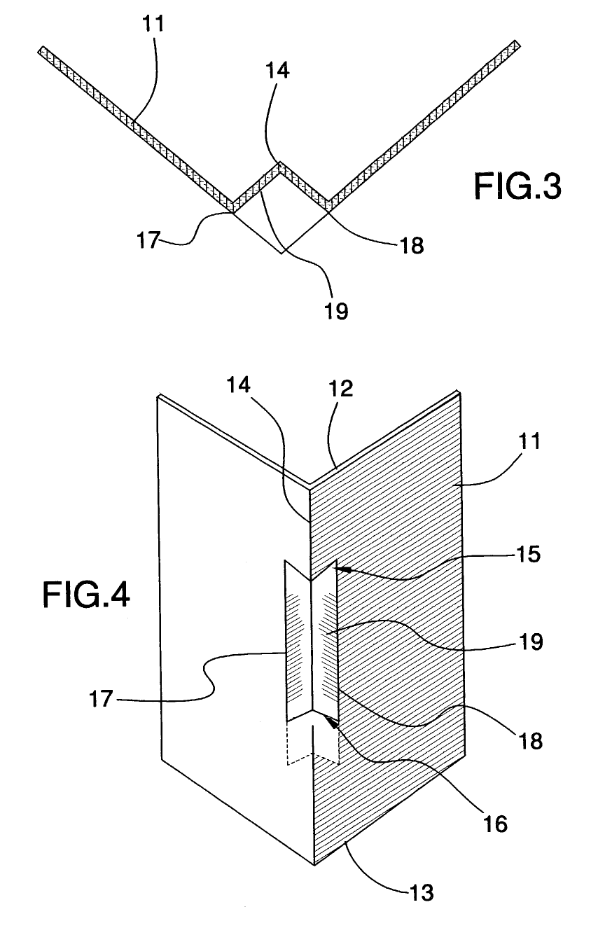

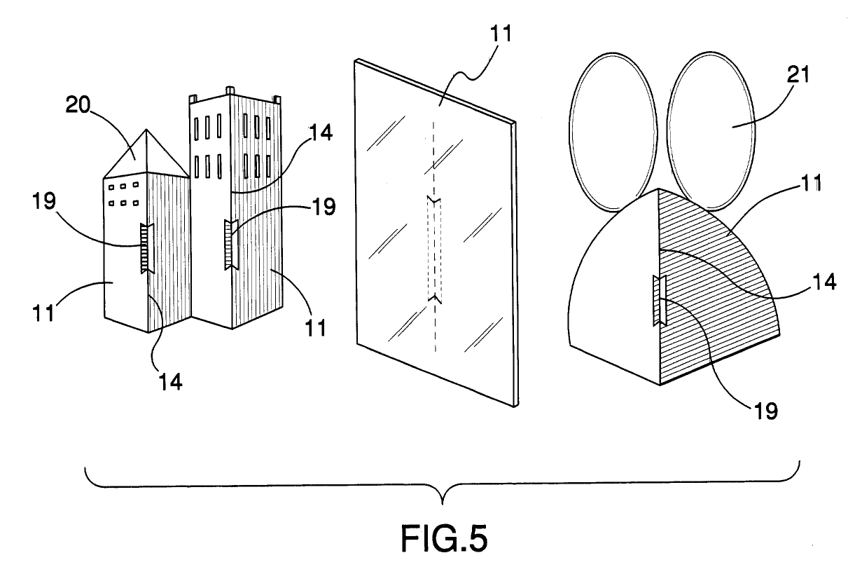

With reference now to the drawings, and in particular to FIGS. 1 through 5 thereof, a new collapsible photograph supporting device embodying the principles and concepts of the present invention and generally designated by the reference numeral 10 will be described.

As best illustrated in FIGS. 1 through 5, the collapsible photograph supporting device 10 generally comprises a sheet of rigid material 11 having top and bottom edges 12,13 and also having one or more main folds 14 extending from the bottom edge 13 to the top edge 12 and dividing the sheet of rigid material 11 into sections and also forming one or more corners upon which one or more photographs is mounted for display with the sheet of rigid material 11 being adapted to rest upon a surface. The sheet of rigid material 11 also includes one or more pairs of slits 15,16 being spaced apart and extending perpendicularly across the one or more main folds 14. The sheet of rigid material 11 further includes one or more pairs of secondary folds 17,18 each extending from ends of a respective pair of slits 15,16 and being generally disposed parallel to the respective main fold 14. The sheet of rigid material 11 also includes one or more recess-able portions 19 formed by the one or more pair of slits 15,16 and the one or more pairs of secondary folds 17,18 and being adapted to receive and support one or more photographs for display upon the sheet of rigid material 11. The sheet of rigid material 11 is generally made of a cardboard material. The sheet of rigid material 11 is capable of being shaped like that of building structures 20 and other various objects 21.

In use, the user folds the sheet of rigid material 11 and stands it up on its bottom edge 13 upon a flat surface, and places one or more photographs in the one or more recess-able portions 19 with the face of the one or more photographs facing away from the one or more recess-able portions 19.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the collapsible photograph supporting device. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A collapsible photograph supporting device comprising:
a sheet of rigid material having top and bottom edges and also having one or more main folds extending from said bottom edge to said top edge and dividing said sheet of rigid material into one or more sections and also forming one or more corners upon which one or more photographs is mounted for display, said sheet of rigid material being adapted to rest upon a surface.

2. The collapsible photograph supporting device as described in claim 1, wherein said sheet of rigid material also includes one or more pairs of slits being spaced apart and extending perpendicularly across said one or more main folds.

3. The collapsible photograph supporting device as described in claim 2, wherein said sheet of rigid material further includes one or more pairs of secondary folds each extending from respective ends of said pair of slits and being generally disposed parallel to a respective said main fold.

4. The collapsible photograph supporting device as described in claim 3, wherein said sheet of rigid material also includes one or more recess-able portions formed by said one or more pairs of slits and said one or more pairs of secondary folds and being adapted to receive and support one or more photographs for display upon said sheet of rigid material.

5. The collapsible photograph supporting device as described in claim 4, wherein said sheet of rigid material is generally made of a cardboard material.

6. The collapsible photograph supporting device as described in claim 5, wherein said sheet of rigid material is capable of being shaped like that of building structures and other various objects.
